(19) United States
(12) Patent Application Publication
(10) Pub. No.: US 2016/0012473 A1
(43) Pub. Date: Jan. 14, 2016

(54) EVALUATION OF ADVERTISEMENTS

(71) Applicant: Prolific Group LLC, New York, NY (US)

(72) Inventors: Mark ZEGAL, Brooklyn, NY (US); Danny Chan, Walnut, CA (US)

(21) Appl. No.: 14/328,011

(22) Filed: Jul. 10, 2014

(51) Int. Cl. G06Q 30/02

(52) U.S. Cl. CPC G06Q 30/0245; G06Q 30/0217; G06Q 30/0267

(57) ABSTRACT

A method for evaluating an advertisement for display on a mobile platform includes providing access to the advertisement via a plurality of mobile devices. Each mobile device is associated with a subscriber to an advertisement evaluation organization. Feedback to the advertisement by the subscriber is solicited via a mobile device that accesses the advertisement. A reward with monetary value is provided to the subscriber that is associated with the in exchange for providing the solicited feedback.

### FIELD OF THE INVENTION

The present invention relates to evaluation of advertisements.

### BACKGROUND OF THE INVENTION

The Internet advertising market includes any website or service where advertising content may be displayed. These include social networks, blogs, personal websites, forums, and groups. More and more people are using smartphones or tablet computers to access the Internet. The percentage of users who access the Internet using smartphones is reaching a saturation point. Website providers are becoming more focused on mobile advertising and trying to monetize the medium.

It is difficult to know in advance how well an Internet advertisement will perform. Many users ignore Internet advertising and view them as a nuisance. Various plug-in applications allow users to disable advertising altogether. In order to be successful, Internet advertising in the mobile medium will need to become more compelling and interesting. With a smaller screen than those of desktop and laptop computers, advertising becomes more difficult to ignore. Therefore, advertisements for the mobile medium may be designed with increased entertainment value.

Traditional advertising agencies typically assign a team to a client or potential client for their advertising campaign. The account team works with the creative staff and with the client to develop a theme or brief for the advertisements. The advertising agency edits and prepares the brief for presentation to the client while providing “story boards.”

Multiple scripts may be presented and feedback is provided with regard to preferred scripts. Client feedback may be provided to the advertising agency. Once an advertisement has been agreed to, the advertisement is created. After creation or during the creation phase, the advertising agency may test the advertisements with a sample group of people. The sample group provides their feedback with regard to the advertisements.

### SUMMARY OF THE INVENTION

There is thus provided, in accordance with an embodiment of the present invention, a method for evaluating an advertisement for display on a mobile platform, the method including: providing access to the advertisement via a plurality of mobile devices, each mobile device being associated with a subscriber to an advertisement evaluation organization; soliciting feedback to the advertisement by the subscriber via a mobile device of the plurality of mobile devices that accesses the advertisement; and providing a reward with monetary value to the subscriber that is associated with a mobile device of the plurality of mobile devices in exchange for providing the solicited feedback.

Furthermore, in accordance with some embodiments of the present invention, the method further includes obtaining profiling information from the subscriber that is associated with a mobile device of the plurality of mobile devices.

Furthermore, in accordance with some embodiments of the present invention, the method further includes providing a reward to the subscriber in exchange for providing the profiling information.

Furthermore, in accordance with some embodiments of the present invention, the plurality of mobile devices is selected on the basis of profiling information that is provided with regard to the subscribers that are associated with the plurality of mobile devices.

Furthermore, in accordance with some embodiments of the present invention, the selected mobiles devices are associated with subscribers whose provided profiling information identifies those subscribers as a target audience for the advertisement.

Furthermore, in accordance with some embodiments of the present invention, providing the access includes enabling a subscriber who is associated with a mobile device of the plurality of mobile devices to select an advertisement for viewing.

Furthermore, in accordance with some embodiments of the present invention, soliciting feedback includes requesting the subscriber to rate the advertisement or to compare two advertisements.

Furthermore, in accordance with some embodiments of the present invention, the method further includes providing an evaluation of the advertisement on the basis of solicited feedback that is received.

Furthermore, in accordance with some embodiments of the present invention, the reward includes a point or credit that is redeemable for a commodity.

Furthermore, in accordance with some embodiments of the present invention, the reward includes an entry in a drawing for a prize.

Furthermore, in accordance with some embodiments of the present invention, the reward includes a commodity.

Furthermore, in accordance with some embodiments of the present invention, the advertisement includes video content.

Furthermore, in accordance with some embodiments of the present invention, providing access includes providing information regarding the reward.

There is further provided, in accordance with some embodiments of the present invention, a non-transitory computer readable storage medium having stored thereon instructions that when executed by a processor will cause the processor to perform the method of: providing access to an advertisement via a mobile device; soliciting feedback to the advertisement from a subscriber that is associated with the mobile device; and providing a reward of monetary value to the subscriber in exchange for providing the solicited feedback.

Furthermore, in accordance with some embodiments of the present invention, the stored instructions include instructions to cause the mobile device to display video content of the advertisement.

Furthermore, in accordance with some embodiments of the present invention, the stored instructions include instructions to receive profiling information regarding the subscriber.

Furthermore, in accordance with some embodiments of the present invention, the stored instructions include instructions to provide a reward of monetary value to the subscriber in exchange for receiving the profiling information.

Furthermore, in accordance with some embodiments of the present invention, the stored instructions include instructions to enable exchange of the reward for a commodity.

Furthermore, in accordance with some embodiments of the present invention, the stored instructions include instructions to evaluate the advertisement on the basis of the solicited feedback that is received from the subscriber.

There is further provided, in accordance with some embodiments of the present invention, a system including: a processing unit in communication with a computer readable medium, wherein the computer readable medium contains a set of instructions wherein the processing unit is designed to carry out the set of instructions to: receive for evaluation an advertisement from an advertiser; provide access to the advertisement via a mobile device; solicit feedback to the advertisement from a subscriber that is associated with the mobile device; provide a reward of monetary value to the subscriber in exchange for providing the solicited feedback; and provide to the advertiser an evaluation of the advertisement based on the solicited feedback that is provided by the subscriber.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 schematically illustrates a system for advertisement evaluation, in accordance with an embodiment of the present invention.

FIG. 2 schematically illustrates a server of the advertisement evaluation system shown in FIG. 1.

FIG. 3 is a flowchart depicting a method for advertisement evaluation, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, us of the conjunction “or” as used herein is to be understood as inclusive (any or all of the stated options).

In accordance with an embodiment of the present invention, an advertisement that is intended for display on a mobile platform may be evaluated. For example, the advertisement may include graphic or video content. The advertisement may be for an offered product. A product may include goods, a service, content (e.g., a trailer or promo for a movie or television show, or similar content), or another subject of an advertisement. The evaluation may performed by a group of potential customers of the advertised product. The evaluation may be performed prior to release of an advertising campaign, during the advertising campaign, or after the advertising campaign.

A mobile platform may include, for example, a smartphone, tablet computer, or similar devices. A mobile platform may include a device that includes portable computerized hardware, such as a smart-watch, glasses, clothing, implants, bionic contact lenses, smart television, automotive multimedia computer, or three-dimensional hologram or laser projection.

Users of mobile platforms are enabled to become subscribers to an advertisement evaluation group or organization. The advertisement evaluation organization may include an advertising agency, a consortium of advertising agencies, or an organization that provides an advertisement evaluation service to one or more advertising agencies. The advertisement evaluation organization may include an independent research or monitoring group that is interested in evaluating advertisements. A subscriber may include an individual, a group of two or more people, a club or organization, or any other subscriber as accepted by the advertisement evaluation organization.

A user may subscribe, register, or open an account with the advertisement evaluation organization, via a website, mobile application, Facebook account, or otherwise. When subscribing, a user may be requested to provide basic information to enable identification and communication with the user. For example, the user may be requested or required to provide one or more of an email address, a telephone number, a password, or other identifying information.

A user may be offered a reward of monetary value in exchange for subscribing to the advertisement evaluation organization. As used herein, monetary value may refer to any point, coupon, credit, or similar entity that may be redeemed to receive money or to be used toward the purchase of goods or services. Monetary value may also refer to entry in, or increasing a number or entries in, a lottery or drawing for money, goods, or services. Monetary value may also refer to free or reduced-price goods or services. In some cases, the advertiser may provide the content of the reward. In some cases, the reward may include the advertised product or a discount toward purchase of the advertised product, The reward may be adapted to be of interest to particular type of subscriber (e.g., individual or group, or particular interests). An offer of a reward may be limited to one (or another number) to a particular subscriber.

When subscribing, the subscriber may be requested or required to provide profiling information. For example, the profiling information may be utilized to associate each subscriber's evaluation with a particular population of potential viewers of the advertisement. For example, profiling information may related to such user characteristics as age, sex, occupation, education, geographical region, socioeconomic status, income, interests, hobbies, or other profiling information. A user may be offered a reward of monetary value in exchange for providing the profiling information. The amount of the reward may be dependent on the amount of profiling information that is provided. The subscriber may be enabled to provide additional profiling information at a time after subscribing. In some cases, at least some profiling information may be automatically determined. For example, information may be provided by a cooperating retail outlet or shopping website regarding a history of purchases by the subscriber.

After subscribing, the advertisement evaluation organization may provide access to one or more advertisements to subscribers to the advertisement evaluation organization. The subscriber may then view one or more of the accessed advertisements. The subscriber may be solicited to provide feedback regarding each viewed advertisement. For example, the subscriber may be requested to, or may be offered an opportunity to, answer one or more questions regarding, or otherwise rate, each viewed advertisement. Solicited answers may include providing a numerical or graphical (e.g., point on a line) rating of one or more aspects of the advertisement. Questions may regard the degree of interest in the advertisement itself, or in the product that is promoted by the advertisement.

The subscriber is offered a reward of monetary value in exchange for providing the feedback. A user interface that enables access to the advertisement may present the nature of the reward to the subscriber.

For example, the amount of the reward may depend on the number of advertisements that were viewed, the number of questions answered regarding each viewed advertisement, or a combination of the above. Various advertisements or questions may be variously rewarded. For example, a larger reward may be offered in exchange for viewing a advertisement for which feedback is urgently required (e.g., an approaching release date or other deadline or milestone), or for answering a question that is considered to be more relevant than another.

Rewards may be offered in exchange for other activities, such as forwarding the advertisement to another user (e.g., not necessarily a subscriber) for viewing, evaluation, or both, for visiting a website that is referenced in the advertisement, or for other activities.

Incentives, e.g., in the form of bonus rewards (e.g., points or credits), or an increased rate of receiving a reward (e.g., more points or credits) for a particular activity, may be offered to selected subscribers. For example, the selected subscribers may include those subscribers who view and evaluate more advertisements than a predetermined number. The number may be an absolute threshold (e.g., a number of views or evaluations in a particular time period, a time spent on viewing or evaluating advertisements, or another absolute threshold), or a may be determined relative to other subscribers (e.g., activity above a particular percentile level of activity).

For example, a subscriber may initiate an interaction with the advertisement evaluation organization at the subscriber's convenience. The subscriber may visit a website or activate and application that enables to access to a set of advertisements that are to be evaluated. Subscribers may be notified or alerted, e.g., via email, text messages, popup windows, an instant messaging service (e.g., WeChat, Viber, WhatsApp, Facebook messenger, or another messaging service), or otherwise. When new advertising content is available for evaluation, or of other events (e.g., a rating contest or competition, or another promotional event). Subscribers may be allowed to indicate convenient times for receiving such notifications or alerts.

The set of advertisements that are made available to a particular subscriber may be specific to that subscriber. For example, the advertisements of the set may be selected from a larger group of advertisements on the basis of profiling information regarding that subscriber. The subscriber may then operate a user interface to select one or more of the set of advertisements for viewing. Selected advertisements may be displayed sequentially. The feedback regarding each viewed advertisement may be solicited immediately following viewing of that advertisement. Alternatively or in addition, feedback may be solicited following viewing of several advertisements. In this case, presented questions may relate comparisons among the viewed advertisements. When the subscriber no longer wishes to view or evaluate advertisements, the subscriber may operate a user interface to indicate termination of the interaction. At the end of the interaction, or at one or more points during the course of the interaction, the subscriber may be informed as to an amount of reward (e.g., an number or points or credits) that were earned during the interaction, or since a time or event preceding the current interaction.

As another example, the advertisement evaluation organization (e.g., a server of the advertisement evaluation organization) may cause one or more advertisements to be displayed on the subscriber's mobile platform. The advertisements that are displayed on a mobile platform of a particular subscriber may be selected specifically for that subscriber. For example, the advertisements to be displayed may be selected from a larger group of advertisements on the basis of profiling information regarding that subscriber. The advertisements may be displayed at predetermined times, or in response to an event (e.g., introduction of a new advertisement or approach of a deadline). In some cases, a subscriber may be enabled to indicate times at which to receive an advertisement for viewing and rating (e.g., a time that is not expected to conflict with a more urgent or higher priority activity). A subscriber may be enabled to indicate conditions under which an advertisement may be received for viewing and rating (e.g., absence of one or more predefined higher priority activity). An advertisement may be appropriately tagged or labeled to identify the advertisement as having originated from the advertisement evaluation organization. In this manner, the subscriber or advertisement-disabling application may be able to distinguish an advertisement that originates from the advertisement evaluation organization, and is therefore to be viewed, from other advertising that the subscriber may prefer to ignore or disable.

A server or processor of the advertisement evaluation organization may evaluate an advertisement based on the feedback. For example, the evaluation may determine effectiveness of an advertisement for one or more target populations. The evaluation may compare relative effectiveness among two or more advertisements for the same or different product. Effectiveness may include quality, viability, and consumer opinion of advertisements in various forms such as video, display, and text.

Evaluation of an advertisement in accordance with an embodiment of the present invention may be advantageous. Effectiveness of the advertisement may be evaluated with respect to a target population in a short time or in real time. Thus, there is no need to gather a group of representative potential viewers for a test screening of the advertisement. The results may be received in a timely fashion. Thus, superfluous expenditure of time or money related to an ineffective advertisement may be avoided. The number of participants in the evaluation may be greater and more representative of the target population or populations than a test group of viewers or the staff of an advertising agency or its client. The participants may represent a wider geographic area (e.g., worldwide) than would viewers in a test group. The advertisement is viewed on the target medium of a mobile platform. Since the subscribers represent a population that may be repeatedly approached, the feedback may be more relevant than a test group who is sampled on a onetime basis. By presentation of the advertisement to each subscriber independently and anonymously, some of the bias that may be present in a test group may be eliminated or reduced. For example, in a test group, it may happen that a few individuals dominate the discussion and others may be embarrassed to express differing opinions.

An offered reward of monetary value may be funded by advertising revenue or otherwise.

An advertiser or advertising agency may upload an advertisement to a server of the advertisement evaluation organization. For example, an advertiser may register or open an account with the advertisement evaluation organization. The registered advertiser may then upload an advertisement in video or other form. The advertiser may also define or indicate one or more target populations. The advertisement evaluation organization may then send the advertisement to subscribers that are members of the target populations. Feedback that is provided by the subscribers may be analyzed. The analyzed feedback may be sent as an evaluation of the advertisement to the registered advertiser.

Rewards (e.g., points or credits) may be exchanged for goods or services. For example, a point or credit may be converted to an entry in a lottery or drawing for a prize of substantial value or that is otherwise attractive to subscribers. Participation in a particular drawing may be limited to a particular population of subscribers (e.g., those subscribers whose profiles indicate that they would find the offered prize to be attractive). A subscriber may be offered the option to participate in a particular drawing, and how many earned points or credits to invest in that drawing.

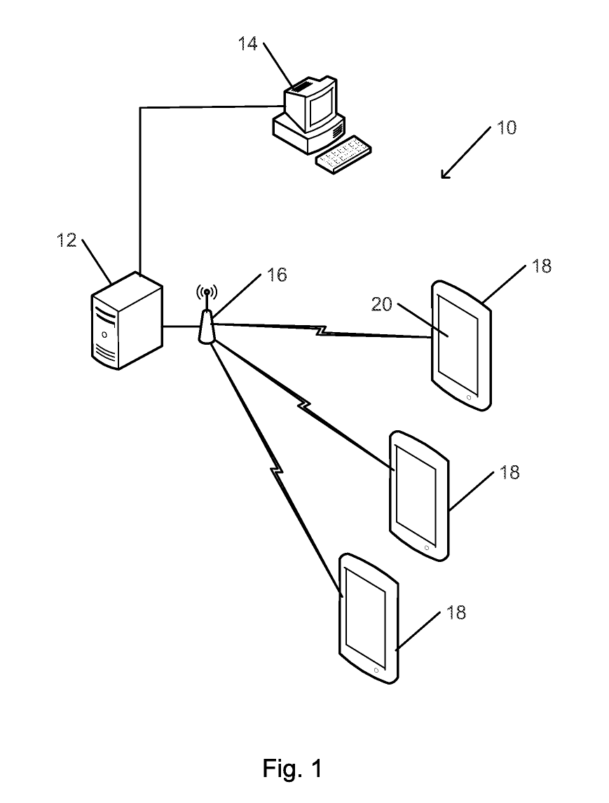

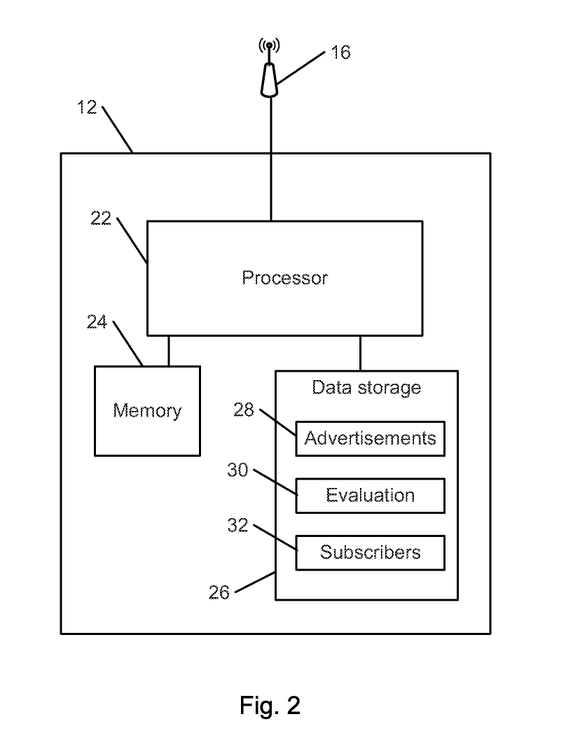

FIG. 1 schematically illustrates a system for advertisement evaluation, in accordance with an embodiment of the present invention. FIG. 2 schematically illustrates a server of the advertisement evaluation system shown in FIG. 1.

Advertisement evaluation system 10 is configured to evaluate one or more advertisements that are produced by one or more advertisers 14. For example, an advertiser 14 may represent a vender, manufacturer, or provider of a product to be advertised. An advertiser 14 may represent advertising agency creator, distributor, publisher, broadcaster, website manager, or another party with an interest in production or distribution of advertisements. An advertiser 14 may represent an investor, advertising department of a media outlet, or other party with an interest in funding or billing for advertising content. The advertisement may be intended for presentation (e.g., visibly or audibly) on mobile devices, such as subscriber mobile platforms 18, or otherwise.

Server 12 of advertisement evaluation system 10 may be operated by an advertisement evaluation organization such as an advertiser, a consortium of advertisers, or a provider of an advertisement evaluation service. Server 12 may be configured to communicate with (e.g., with a computer of) one or more advertisers 14. For example, an advertiser 14 may transmit an advertisement that is to be evaluated to server 12. Server 12 may communicate to advertiser 14 an evaluation of the advertisement, or subscriber ratings that may be analyzed to evaluate the advertisement. Communication of server 12 with advertiser 14 may be via a wired or wireless communications channel, e.g., a network.

Server 12 is provided with wireless connection 16 to communicate with a plurality of subscriber mobile platforms 18. For example, server 12 may transmit one or more advertisements to a subscriber mobile platform 18 for presentation. Server 12 may also transmit to subscriber mobile platform 18 a request for feedback with regard to the advertisements. Server 12 may receive from subscriber mobile platform 18 user feedback that relates to a transmitted advertisement.

A subscriber mobile platform 18 may include input/output device 20. For example, input/output device 20 may represent a touch screen. Input/output device 20 may represent separate input and output devices, such as a display screen (e.g., with a speaker) together with user operable controls (e.g., pointing device, keyboard or keypad, button, switch, or other control). Input/output device 20 may be operated to present an advertisement to a user, to solicit feedback, to input feedback, or any combination of the above. Each subscriber mobile platform 18 may be uniquely indentified, e.g., by one or more identification numbers that relate to various hardware or software components of subscriber mobile platform 18.

Server 12 includes a processor 22. For example, processor 22 may include one or more processing units, e.g. of one or more computers. Processor 22 may be configured to operate in accordance with programmed instructions stored in memory 24. Processor 22 may be capable of executing an application for advertisement evaluation.

Processor 22 may communicate with memory 24. Memory 24 may include one or more volatile or nonvolatile memory devices. Memory 24 may be utilized to store, for example, programmed instructions for operation of processor 22, data or parameters for use by processor 22 during operation, or results of operation of processor 22

Processor 22 may communicate with data storage device 26. Data storage device 26 may include one or more fixed or removable nonvolatile data storage devices.

Data storage device 26 may be utilized to store advertisements 28. Advertisements 28 may be organized in the form of a database from which an advertisement may be retrieved on the basis of one or more characteristics or parameters. Advertisements 28 may include a group of advertisements that were submitted for evaluation by one or more advertisers 14. Each stored advertisement of advertisements 28 may be associated with one or more characteristics. The characteristics may relate to a target population. The characteristics may include a list of identifiers of those subscriber mobile platforms 18 on which a particular advertisement has already been displayed or rated. The characteristics may include one or more parameters indicative of a priority or relative need or urgency to evaluate each advertisement.

Data storage device 26 may be utilized to store subscribers 32. Subscribers 32 may be organized in the form of a database from which a subscriber may be retrieved on the basis of one or more characteristics or parameters. Subscribers 32 may include identification of subscriber mobile platforms 18. Each stored subscriber of subscribers 32 may be associated with one or more characteristics. The characteristics may relate to a population with which each subscriber mobile platform 18 is associated. The characteristics may include a list of identifiers of those advertisements that had already been displayed on or rated by each subscriber. The characteristics may include a reward status (e.g., points earned, rate at which points are earned, or other status related to rewards) that relates to each subscriber of subscribers 32.

Data storage device 26 may include a computer readable medium for storing program instructions for operation of processor 22. For example, the programmed instructions may take the form of evaluation module 30. Evaluation module 30 may include instruction for identifying a subscriber of subscribers 32 to which an advertisement of advertisements 28 is to be submitted for viewing and rating. For example, the selection may be based on a match between a target population of the advertisement to a population to which a particular subscriber belongs, previous viewing by that subscriber, or on the basis of other considerations. Evaluation module 30 may include instruction for soliciting feedback from the subscriber, and for automatically evaluating the advertisement on the basis of the feedback.

It is noted that one, more, or all components of data storage device 26 may be remote from processor 22. In such cases data storage device 26 may represent a storage device of a remote server storing evaluation module 30 in the form of an installation package or packages that can be downloaded and installed for execution by processor 22. Data storage device 26 may be utilized to store data or parameters for use by processor 22 during operation, or results of operation of processor 22.

In operation, processor 22 may execute a method for advertisement evaluation.

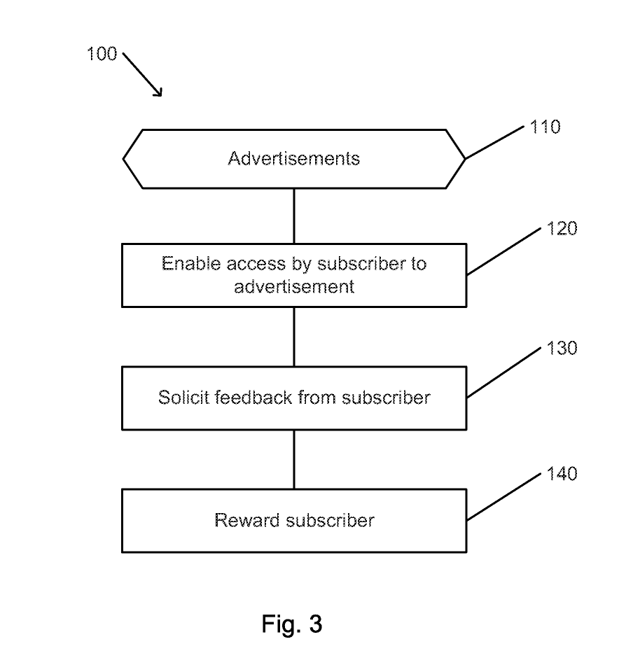

FIG. 3 is a flowchart depicting a method for advertisement evaluation, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Advertisement evaluation method 100 may be executed by a processor, e.g., of a server, of a system for advertisement evaluation. Advertisement evaluation method 100 may be executed upon a request or command that is issued by a user or that is automatically issued by another application. Advertisement evaluation method 100 may be performed automatically periodically, at predetermined times, in response to an event, or otherwise.

Advertisement evaluation method 100 may be executed when one or more advertisements are available for evaluation (block 110). For example, advertisements from one or more advertisers may be loaded into a database. An advertisement may be intended for one or more target populations. An advertisement may be characterized by a priority or urgency (e.g., intended deadline for release or other factor that influences priority or urgency).

Access by one or more subscribers using mobile devices may be enabled (block 120). For example, the subscriber may be enabled to operate that subscriber's mobile device to view the advertisement. A notification may be sent to the subscribers' mobile devices to notify the subscribers of the availability of the advertisement for viewing. The advertisement may be sent to the subscriber's mobile device in the form of an email or popup window. Access may be enabled at predetermined times, or may be initiated by an action of the processor or of the subscriber.

A subset of all subscribers may be selected to whom access to a particular advertisement is enabled. For example, the subset may be selected on the basis of profiling information that is received from each subscriber, e.g., at a time of subscribing or at a later time. The subset may include those subscribers that, on the basis of the profiling information, are identified as being in a target audience of the advertisement. The subset may be selected on the basis of other criteria (e.g., past activity with regard to other advertisements, or other criteria).

Feedback with regard to a viewed advertisement may be solicited from all or some of subscribers that access the advertisement (block 130). For example, a user interface may be opened on the subscriber's mobile device that requests a rating from the subscriber. Alternatively or in addition, the subscriber may be asked a series of one or more questions, the answers to which may be indicative of a quality or aspect of the viewed advertisement. For example, ratings or questions may relate to one or more of attention paid to the advertisement, content of the advertisement that is remembered by the subscriber, entertainment value of the advertisement, interest in the advertisement, likelihood to purchase the advertised product, or another aspect of the advertisement. The feedback may relate to two or more different aspects of the advertisement. The feedback may include one or more of answering a simple yes-no question (e.g., “like” or “dislike,” or similar yes-no response), may include scoring or rating in accordance with a scale (e.g., an numerical, alphabetic, verbal, graphic, or other scale), may include a free-text answer to a question, comparison of two or more advertisements, or other types of responses or feedback.

The feedback from a plurality of subscribers may be analyzed to evaluate one or more aspects of the advertisement. For example, an aspect of the advertisement (e.g., interest, memorability, effectiveness, entertainment value, or another aspect) may be rated or scored with a numeric, alphabetic, verbal, graphic, or other score. The evaluation may be transmitted to the advertiser, or to another interested party.

The subscriber may be rewarded for providing feedback, or anther activity related to evaluation of the advertisement (block 140). For example, the subscriber may be rewarded for subscribing, for providing profiling information, for viewing an advertisement, for recommending another subscriber, for demonstrating further interest in an advertised product (e.g., following a link that is embedded in the advertisement), or another related activity. The rate or amount of the rewarding may be determined by an amount or frequency of feedback that is provided by the subscriber, or of another related activity by the subscriber. The reward may be an amount of money or of other monetary value. For example, the reward may include points or credits that may be applied toward purchasing or obtaining an article, service, entertainment, entries in a drawing for a prize of value, or other commodity of value. The reward may include a commodity of value. An offered reward may be customized for a particular subscriber. For example, the offered reward may be selected for a subscriber on the basis of an indication of likes or interests in the profiling information.

The subscriber may be informed of an offered reward for providing feedback or another activity prior to soliciting feedback, after the subscriber provides feedback or performs another activity, or during an interaction with the subscriber.

1. A method for evaluating an advertisement for display on a mobile platform, the method comprising:
providing access to the advertisement via a plurality of mobile devices, each mobile device being associated with a subscriber to an advertisement evaluation organization;
soliciting feedback to the advertisement by the subscriber via a mobile device of said plurality of mobile devices that accesses the advertisement; and
providing a reward with monetary value to the subscriber that is associated with a mobile device of said plurality of mobile devices in exchange for providing the solicited feedback.

2. The method of claim 1, further comprising obtaining profiling information from the subscriber that is associated with a mobile device of said plurality of mobile devices.

3. The method of claim 2, further comprising providing a reward to the subscriber in exchange for providing the profiling information.

4. The method of claim 1, wherein said plurality of mobile devices is selected on the basis of profiling information that is provided with regard to the subscribers that are associated with said plurality of mobile devices.

5. The method of claim 4, wherein the selected mobiles devices are associated with subscribers whose provided profiling information identifies those subscribers as a target audience for the advertisement.

6. The method of claim 1, wherein providing the access comprises enabling a subscriber who is associated with a mobile device of said plurality of mobile devices to select an advertisement for viewing.

7. The method of claim 1, wherein soliciting feedback comprises requesting the subscriber to rate the advertisement or to compare two advertisements.

8. The method of claim 1, further comprising providing an evaluation of the advertisement on the basis of solicited feedback that is received.

9. The method of claim 1, wherein the reward comprises a point or credit that is redeemable for a commodity.

10. The method of claim 1, wherein the reward comprises an entry in a drawing for a prize.

11. The method of claim 1, wherein the reward comprises a commodity.

12. The method of claim 1, wherein the advertisement includes video content.

13. The method of claim 1, wherein providing access comprises providing information regarding the reward.

14. A non-transitory computer readable storage medium having stored thereon instructions that when executed by a processor will cause the processor to perform the method of:
providing access to an advertisement via a mobile device;
soliciting feedback to the advertisement from a subscriber that is associated with the mobile device; and
providing a reward of monetary value to the subscriber in exchange for providing the solicited feedback.

15. The non-transitory computer readable storage medium of claim 14, wherein the stored instructions include instructions to cause the mobile device to display video content of the advertisement.

16. The non-transitory computer readable storage medium of claim 14, wherein the stored instructions include instructions to receive profiling information regarding the subscriber.

17. The non-transitory computer readable storage medium of claim 16, wherein the stored instructions include instructions to provide a reward of monetary value to the subscriber in exchange for receiving the profiling information.

18. The non-transitory computer readable storage medium of claim 14, wherein the stored instructions include instructions to enable exchange of the reward for a commodity.

19. The non-transitory computer readable storage medium of claim 14, wherein the stored instructions include instructions to evaluate the advertisement on the basis of the solicited feedback that is received from the subscriber.

20. A system comprising:
a processing unit in communication with a computer readable medium, wherein the computer readable medium contains a set of instructions wherein the processing unit is designed to carry out the set of instructions to:
receive for evaluation an advertisement from an advertiser;
provide access to the advertisement via a mobile device;
solicit feedback to the advertisement from a subscriber that is associated with the mobile device;
provide a reward of monetary value to the subscriber in exchange for providing the solicited feedback; and
provide to the advertiser an evaluation of the advertisement based on the solicited feedback that is provided by the subscriber.
